(19) United States
(12) Patent Application Publication
(10) Pub. No.: US 2003/0116306 A1
(43) Pub. Date: Jun. 26, 2003

(54) Rotating film shell and tube type heat exchanger - evaporator

(76) Inventor: Ferdinand K. Besik, Mississauga (CA)

Correspondence Address: Ferdinand Besik, 2562 Oshkin Crt., Mississauga, ON, L5B 3Z3, CA

(21) Appl. No.: 10/025,731

(22) Filed: Dec. 26, 2001

(51) Int. Cl. F15D 1/00; F28F 13/12; F28D 7/00; F28F 9/22; F28F 1/00

(52) U.S. Cl. 165/109.1; 165/159; 165/177; 138/38

(57) ABSTRACT

A shell and tube type heat exchanger-evaporator for applications involving vapour-liquid separation and evaporation of refrigerants has a plurality of heat exchange tubes provided with an internal baffle that converts the straight tube channel of a standard heat exchange tube into two semi-circularly sectioned spiral channels. The two spiral channels define a spiralling flow path for the vapour generated in the heat exchange tube from a boiling liquid. The generated vapour flows through the two spiral channels with increasing velocity driving the unevaporated boiling liquid in a spirally rotating film of diminishing thickness over the whole internal wall of the heat exchange tube increasing the heat exchange capacity of the heat exchange tube. The fine droplets of the boiling liquid generated during the boiling process are continuously separated from the stream of the generated vapour by impingement on the body of the internal baffle and by centrifugal acceleration of the spiralling flow of the generated vapour. Because of the rotation of the vapour and boiling liquid in the heat exchange tube, the heat exchanger-evaporator can operate with high efficiency in a horizontal position or in vertical position either as a down flow or an up flow unit.

### FIELD OF INVENTION

The present invention relates to an indirect transfer of heat in shell and tube type heat exchangers and evaporators between the fluids passing through the heat exchange tubes and the shell. More specifically, the invention relates to a shell and tube type heat exchangers and evaporators in which the fluid passing through the heat exchange tubes is a two-phase fluid of a boiling liquid and vapour as encountered in applications involving vapour-liquid separation and in evaporation of refrigerants.

### BACKGROUND

Briefly, the shell and tube heat exchangers and evaporators are devices comprising a plurality of heat exchange tubes encased within a single larger shell involving an indirect transfer of heat between a fluid passing through the tubes and another fluid passing through the shell. The fluid passing through the tubes may be a liquid or a two-phase fluid of a boiling liquid and vapour and the fluid passing through the shell may be a liquid, condensing vapour or a gaseous fluid.

The information on the involved heat transfer mechanism and on the design of the various types shell and tube heat exchangers and evaporators is presented in “Chemical Engineer's Handbook, Fifth Edition, R. H. Perry and C. H. Chilton, McGraw-Hill Book Company, New York, Sections 10 and 11”, in “Equipment Design Handbook for Refineries and Chemical Plants, Volume 2, Frank L. Evans, Jr., by Gulf Publishing Company, Houston, Tex., 1974”, and in “Compact Heat Exchangers, Second Edition, W. M. Kays and A. L. London, McGraw-Hill Book Company”.

In refrigeration, the shell and tube evaporator is a component of a vapour compression refrigeration system that includes a refrigerant circulating in a closed loop between the evaporator, compressor, condenser and an expansion valve. It is used for evaporation of the refrigerant. The principles of refrigeration are presented in the Chemical Engineer's Handbook, Fifth Edition, R. H. Perry and C. H. Chilton, McGraw-Hill Book Company, New York, Sections 12.

The physical, chemical, thermodynamic and transport properties of the various substances and refrigerants that can be circulated through the heat exchange tubes, or that can be used as the second fluid, are presented in “Chemical Engineer's Handbook, Fifth Edition, R. H. Perry and C. H. Chilton, McGraw-Hill Book Company, New York, Section 3”, and in “Handbook of Chemistry and Physics, Forty Ninth Edition, R. C. Weast, Ph.D., Published by The Chemical Ruber Co., Cleveland, Ohio, 1968”.

The information on a two-phase flow in channels and on separation of droplets by gravity and centrifugal acceleration is presented in “Chemical Engineer's Handbook, Fifth Edition, R. H. Perry and C. H. Chilton, McGraw-Hill Book Company, New York, Sections 5 and 19”.

The current art shell and tube evaporators used in vapour compression refrigeration systems suffer from an uneven distribution of the liquid refrigerant into the plurality of the heat exchange tubes and from stratification of the refrigerant vapour-liquid mixture inside the heat exchange tubes causing only a fraction of the internal wall of the heat exchange tube being utilized for boiling, resulting in low overall heat transfer rates of 200-400 BTU/ft²/hr/° F. More, the current art evaporators suffer from considerable entrainment of the liquid refrigerant causing impairment of the overall efficiency of the refrigeration system.

To improve the performance and efficiency of evaporators used in refrigeration systems, an improved distributor for the refrigerant vapour liquid mixture is described in U.S. Pat. No. 5,842,351 and various different forms of heat exchanger tubes and inserts in U.S. Pat. Nos. 2,318,206, 3,244,601, 3,339,631, 4,034,964, 4,086,959, 4,090,559, 4,183,682, 4,373,578, 4,534,409, 4,658,892, 5,010,643, 5,167,275, 5,454,429 and 6,092,589. However, non of these previously known devices include the structural and operational features of the instant invention, nor are they as readily constructed at low cost.

### SUMMARY OF THE INVENTION

The present invention includes a shell and tube type heat exchanger-evaporator that has a plurality of heat exchange tubes provided with an internal baffle that converts the straight tube channel of a standard heat exchange tube into two semi-circularly sectioned spiral channels. The two spiral channels define a spiralling flow path for the vapour generated in the heat exchange tube from a boiling liquid. The generated vapour flows through the two spiral channels with increasing velocity driving the unevaporated boiling liquid in a spirally rotating film of diminishing thickness over the whole internal wall of the heat exchange tube increasing the overall heat transfer rate and the heat exchange capacity of the heat exchange tube. The evaporator's intake nozzle distributes a vapour-liquid mixture into the plurality of the heat exchange tubes via a full cone spray. The fine droplets of boiling liquid entering the heat transfer tubes and those generated during the boiling process are continuously separated from the generated vapour by impingement on the body of the internal baffle and by centrifugal acceleration of the spiralling flow of the generated vapour. Because of the rotation of the generated vapour and boiling liquid in the heat exchange tube, the heat exchanger-evaporator of the invention can operate with high efficiency in a horizontal position or in vertical position either as a down flow or an up flow unit.

The main object of this invention is to increase the overall heat transfer rate of the current art shell and tube type heat exchangers-evaporators by providing a rotating film of boiling liquid of diminishing thickness on the internal walls of the heat exchange tubes.

Another object of this invention is to eliminate the entrainment of the current art shell and tube type evaporators by separating the fine droplets of the boiling liquid from the generated vapour by a combined mechanism of impingement and centrifugal acceleration.

Another object of the invention is to provide for the heat exchange tube of the current art shell and tube type heat exchangers and evaporators a baffle that would change the current straight flow path of a mixture of boiling liquid and vapour to a rotating flow path of separated boiling liquid and vapour.

Another object of the invention is to provide for a heat exchange tube of shell and tube type heat exchangers and evaporators a baffle that would minimally restrict the cross sectional area of the heat exchange tube.

Another object of the invention is to provide for a heat exchange tube of a shell and tube type heat exchangers and evaporators a baffle that could be readily inserted into and held in the heat exchange tube.

Another object of the invention is to provide for a heat exchange tube of a shell and tube type heat exchangers and evaporators a baffle that could be manufactured from a suitable plastic or metal material.

Another object of the invention is to provide a shell and tube type heat exchanger-evaporator that could operate in horizontal position or in vertical position as a down flow or an up flow unit with high efficiency.

Another object of the invention is to provide for a shell and tube type evaporator an intake nozzle that would evenly distribute the recirculating boiling liquid into the plurality of the heat exchange tubes.

A final object of this invention to be specifically enumerated in here is to provide for a heat exchange tube of a shell and tube type heat exchanger-evaporators an internal baffle and a distributor which will be of simple construction, easy to use, economically feasible, long lasting and would provide trouble-free operation.

These together with other objects and advantages of the invention will become apparent from an examination of the following description and the appended drawings and claims.

### BRIEF DESCRIPTION OF DRAWINGS

FIG. 1 is a schematic illustration of a sectional view of a preferred embodiment of a rotating film horizontal shell and tube type heat exchanger-evaporator of the invention.

FIG. 2 is a longitudinal cutaway view of one heat exchange tube assembly of the invention.

FIG. 3 represents an enlarged view of a transverse section taken along the line A-A of the heat exchange tube assembly of FIG. 2.

FIG. 4 is a view of a preferred embodiment of the internal baffle of the invention used in the heat exchange tube assembly of FIG. 2.

FIG. 5 represents an enlarged view of a transverse section taken along the line A-A of the internal baffle of the invention of FIG. 4.

FIG. 6 represents an enlarged view of a transverse section showing a cross sectional profile of an internal baffle of another preferred embodiment of the invention.

FIG. 7 is a schematic illustration of a sectional view of a preferred embodiment of a vertical down flow shell and tube type heat exchanger-evaporator of the invention illustrated in FIG. 1.

FIG. 8 is a schematic illustration of a sectional view of a preferred embodiment of a vertical up flow shell and tube type heat exchanger-evaporator of the invention illustrated in FIG. 1.

### DETAILED DESCRIPTION OF THE PREFERRED EMBODIMENTS

While the present invention may be used with the various types shell and tube heat exchangers and evaporators described in the cited references, it has particular application in evaporators used in the vapour compression refrigeration systems for evaporation of a refrigerant.

In a typical vapour compression refrigeration system, not shown in here, the refrigerant is being circulated by a compressor in a closed loop between an evaporator, compressor, condenser and an expansion valve. The expansion valve changes the high pressure liquid refrigerant to a low pressure-low temperature refrigerant vapour-liquid mixture, the composition and temperature of which is fixed by the pressure and temperature of the liquid refrigerant entering the expansion valve and the operating pressure of the evaporator. The evaporator is being used to indirectly cool a second fluid by boiling and evaporating the refrigerant. The second fluid may be water, brine, glycol, oil, an industrial gas, air or vapour.

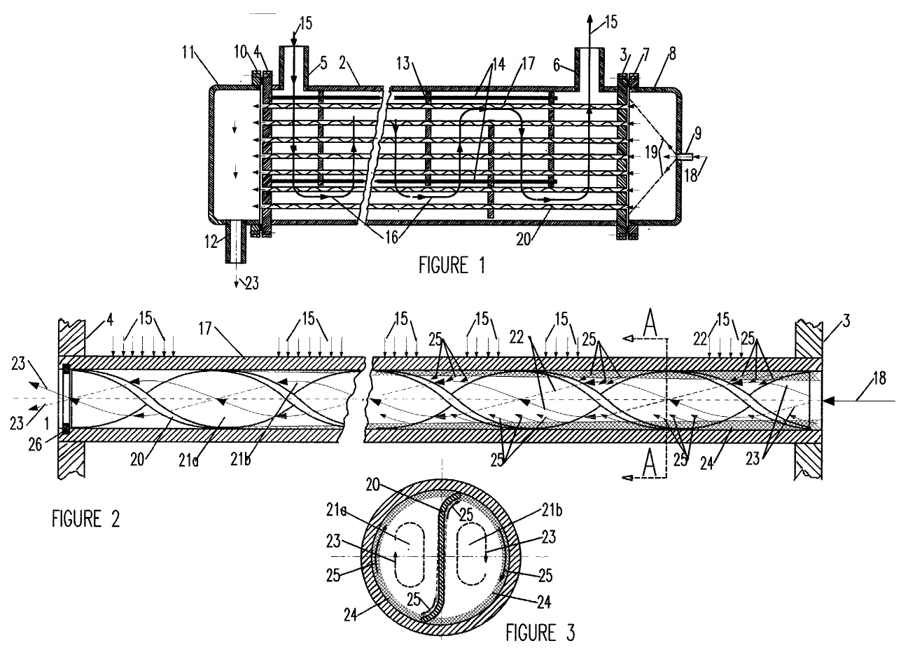

One preferred embodiment of a shell and tube type heat exchanger-evaporator of the invention intended for cooling of a second fluid (liquid) by boiling and evaporating first fluid (refrigerant) is schematically illustrated in FIG. 1.

The heat exchanger-evaporator 1 includes shell 2 provided at first end with fixed tube sheet 3 and at the second end with fixed tube sheet 4. Shell 2 is also provided with an intake nozzle 5 and exit nozzle 6. At its first end the evaporator has a stationary head flange 7 attached to head bonnet 8 provided with refrigerant intake nozzle 9 and, at its second end it has a stationary head flange 10 attached to head bonnet 11 provided with refrigerant exit nozzle 12. The shell space is separated by baffles 13, held in position by tie rods and spacers 14, into a number of compartments directing the flow of a second fluid 15 through the shell space as indicated by arrows 16.

The heat exchanger-evaporator 1 is provided with a plurality of heat exchange tubes 17 provided with internal baffles 20 extending between the stationary tube sheets 3 and 4, with the heat exchange tubes 17 being in direct fluid communication with chambers of said head bonnets 8 and 11.

Intake nozzle 9 positioned in the centre of the head bonnet 8 sprays the refrigerant vapour-liquid mixture 18 into plurality of heat exchange tubes 17 via a full cone spray indicated by the broken lines 19. Nozzle 9 which produces a full cone spray of an angle of about 120° is commercially available in a number of different sizes and of cone angles and therefore, it is not further described in here. The refrigerant vapour-liquid mixture 18 is forced through the plurality of heat transfer tubes 17 by the refrigerant compressor (not shown in here). The heat for boiling of refrigerant is provided by the second fluid 15 and is transferred to the refrigerant indirectly through the heat exchange tubes 17 from the second fluid 15 passing through the shell space.

As illustrated in FIG. 2 and FIG. 3 in more detail, a tube assembly of one preferred embodiment of the invention comprises a standard heat exchange tube 17 provided with an internal baffle 20. The internal baffle 20 converts the straight tube channel into two semi-circularly sectioned spiral channels 21a, 21b. The two spiral channels define a spiralling flow path 22 for the refrigerant vapour 23 generated in the heat exchange tube from a film of liquid refrigerant 24 entering the tube 17 with the refrigerant vapour-liquid mixture 18. The generated refrigerant vapour, indicated by arrows 23, flows through the two spiral channels 21a, 21b with increasing velocity driving the unevaporated refrigerant film 24 through the tube 17 in a spirally rotating film of diminishing thickness as indicated by arrows 25, increasing the heat transfer rate on the inside of the heat exchange tube 17. The heat exchange tube 17 is provided with removable ring 26 positioned at the exit end of the heat exchange tube 17 to lock the internal baffle 20 within the heat exchange tube 17. The outside diameter of the heat exchange tubes, depending on application, may vary from ⅜″ to 2.5″, with a preferred diameter of tubes used in refrigeration systems ranging from 0.5″-0.75″.

The refrigerant vapour-liquid mixture 18, depending on the properties of the used refrigerant, enters the heat exchange tubes 17 at a preferred superficial velocity ranging from 2 to 7 ft/sec and the vaporised refrigerant 23 exits the heat exchange tubes at superficial velocities ranging from 10 to 35 ft/sec.

The diameter of droplets, generated by the refrigerant intake nozzle 9 entering the heat transfer tube 17, varies in the range from 100 to 2000 microns, with their terminal (gravity) settling velocities, depending on the properties of the refrigerant, increasing with a droplet diameter from about 1 ft/sec for a 100-micron diameter droplet to about 7 ft/sec for a 2,000 micron diameter droplet. The size of droplets generated in the boiling process varies in the rage from 5 microns to 200 microns, with the terminal (gravity) settling velocity of the 5-micron diameter droplet of about 0.008 ft/sec.

As the volumetric ratio of the refrigerant vapour and liquid at the entrance of the heat transfer tubes 17, depending on the refrigerant properties, varies in the range from 10 to 50 and is increasing to infinity with evaporation of the liquid refrigerant, the refrigerant vapour drives the refrigerant liquid on the inside walls of the heat exchange tubes in a rotating film of increasing radial velocity. As a result, the liquid refrigerant is being boiled and evaporated at a high rate that is limited and controlled by the heat transfer rate occurring on the outside wall of the heat transfer tube.

As the liquid refrigerant boils and evaporates as it passes through the two spiral channels in the heat exchange tube, the droplets of refrigerant entering the heat exchange tube with the refrigerant vapour-liquid mixture 18 and those generated in the boiling process are separated from the refrigerant vapour 23 by impingement on the body of the internal baffle 20 and by the centrifugal acceleration of the spiralling flow of the vaporized refrigerant 23 of increasing radial velocity. As an example, the centrifugal acceleration for typical refrigerants at the entrance of the heat exchange tube is in a range from 10 g to 50 g and increases along the tube up to about 200 g to 1,000 g at the tube exit. Thus, due to the high centrifugal acceleration of the refrigerant vapour at the exit end of the heat exchange tube, there is no entrainment of fine droplets of refrigerant out of the heat exchange tube assembly of this invention.

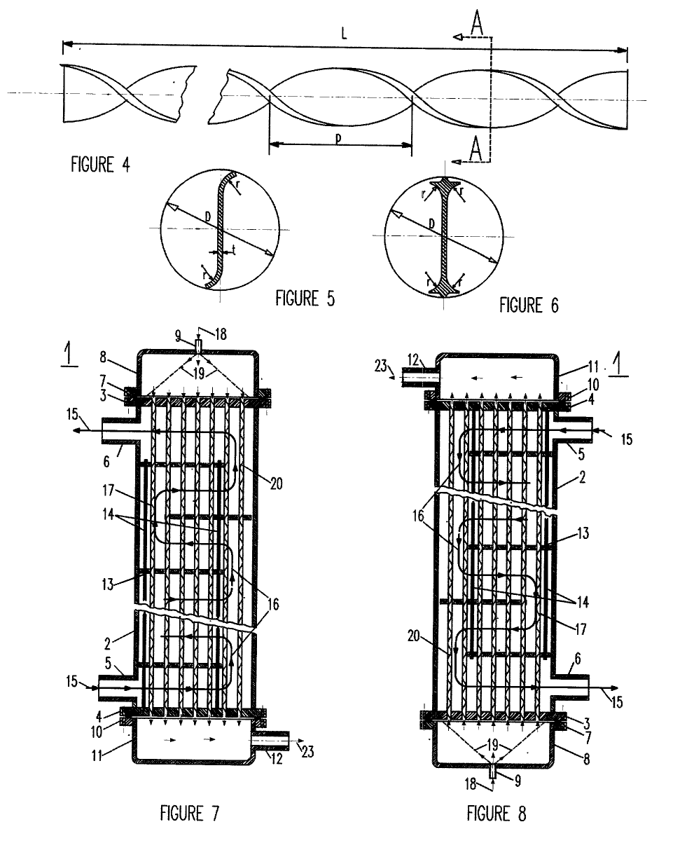

As illustrated in FIG. 4 and FIG. 5, the internal baffle 20 has a length “L”, pitch “p” and a cross sectional profile defined by the thickness “t”, radius “r”, and diameter D, all being provided to induce the desired rotation of the vaporized refrigerant and of the refrigerant liquid film on the internal wall of the heat exchange tube 17 to increase the heat exchanging capacity of the heat exchange tube 17 and to separate the fine droplets of refrigerant from the refrigerant vapour 23. The preferable length “L” of the tube and baffle 20 is in the range from 6 to 15 feet, the baffle pitch “p” in the range from 1 to 5 inches and the baffle radius “r” in the range from 0.1 D to 0.5 D, where D is the internal diameter of the heat exchange tube 17.

The internal baffle 20 is made of a material that is chemically compatible with the metal heat exchange tube 17, operating temperature and the refrigerant flowing through the heat exchange tube 17 and that does not otherwise impose practical or application problems. As an example, depending on the preferred manufacturing process, the baffle 20 may be made of polyethylene, polypropylene, Teflon, aluminum, high-alloyed austenitic steel, nickel-chromium alloys or Monel. Of these, the least expensive and preferred materials are the polyethylene and polypropylene, that provide easy manufacturing and optimum strength and flexibility required for easy insertion of the baffle 20 into the heat exchange tube 17.

The centrifugal acceleration induced by the internal baffle 20 depends on the properties of refrigerant, baffle dimensions “p”, “t”, “r”, “D” and superficial velocity of the vaporised refrigerant 23 in the heat exchange tube 17. The preferred centrifugal acceleration at the heat exchange tube entrance is in a range from 10 g to 50 g and at the tube exit in a range from 200 g to 1,000 g and may be varied by the baffle pitch “p”.

While the embodiment of the invention described in FIGS. 2, 3, 4 and 5 shows the baffle 20 having a constant pitch “p” along the baffle length “L”, it can be appreciated by those with skill in the art that for applications with different refrigerants and different compositions of the refrigerant vapour-liquid mixture 18 entering the evaporator 1, it may be preferable to have a varied or a different pitch “p” at the entrance, along the central portion of the tube length “L” or at the end part of the tube.

While the embodiment of the invention described in FIGS. 2, 3, 4 and 5 shows the baffle 20 having a cross sectional profile defined by dimensions “t”, “r”, “D” with a constant thickness “t”, it can be also appreciated by those with skill in the art that baffle 20 may have a different cross sectional profile, while still providing the desired rotating spiralling flow of the refrigerant vapour and liquid film described in FIGS. 2 and 3. As an example, FIG. 6 shows a cross sectional profile of the internal baffle of another embodiment of the invention that would also provide the rotating spiralling flow of the refrigerant vapour and liquid film described in FIGS. 2 and 3.

While the embodiment of the invention described in FIGS. 1, 2 and 3 shows the heat exchange tubes 17 as straight tubes with smooth internal and external wall surfaces, it can be also appreciated by those with skill in the art that the heat exchange tubes 17 may be of various metal compositions, with smooth or with sintered metal deposit coated internal wall surfaces and with smooth or extended outside wall surfaces provided by the various commercially available axial or radial fins, that the tubes may be also of a U-type shape and that they may or may not be provided with the end ring 26.

While the embodiment of the invention described in FIGS. 1, 2, 3, 4 and 5 shows a specific configuration of a shell and tube type heat exchanger 1, it can be also appreciated by those with skill in the art that the invention illustrated in FIG. 2, 3, 4 and 5 can be also effectively used in the various types shell and tube type heat exchangers and evaporators described in detail in the cited references and, with the body of the shell 2 being of a circular or a rectangular shape with or without the baffles 13.

While the embodiment of the invention illustrated in FIGS. 1, 2, 3, 4 and 5 was described in an application with the first fluid being a refrigerant and the second fluid a liquid, it can be also appreciated by those with skill in the art that the invention can be also used in other heat exchange applications involving a single or two phase fluids with properties described in the cited references.

FIG. 7 is a schematic illustration of a sectional view of another preferred embodiment of the invention showing a vertical down flow rotating film shell and tube type evaporator 1 having the heat exchange tubes 17 provided with internal baffles 20 of the invention described in FIGS. 2, 3, 4 and 5.

FIG. 8 is a schematic illustration of a sectional view of another preferred embodiment of the invention showing a vertical up flow rotating film shell and tube type evaporator 1 of the invention having the heat exchange tubes 17 provided with internal baffles 20 of the invention described in FIGS. 2, 3, 4 and 5.

While the present invention has been described with reference to specific embodiments in a specific application to demonstrate the features and advantages of the invention, such specific embodiments are susceptible to modifications to fit other configurations or other applications. Accordingly, the forgoing description is not to be construed in a limiting sense.

1. A heat exchange tube assembly for heat exchangers and evaporators for increasing the rate of indirect transfer of heat between first fluid passing through and in contact with the inside wall of said heat exchange tube assembly and a second fluid passing on the outside and in contact with the outside wall of said heat exchange tube assembly comprising:
a metal heat exchange tube means having inner and outer wall surfaces and an opened inlet end for receiving said first fluid, flowing said first fluid there through and an opened outlet end for discharging said first fluid, and
a baffle means inserted and centrally disposed within said heat exchange tube means, said baffle means having a diameter substantially equal to the internal diameter of said heat exchange tube means, said baffle means separating the straight circular channel of said heat exchange tube means into two semi-circularly sectioned spiral channels extending along the length of said heat exchange tube means, said spiral channels providing a rotating spiralling flow path for said first fluid passing there through, said rotating spiralling flow of said first fluid generating centrifugal acceleration within said rotating first fluid and with said baffle means being made of a material chemically compatible with said metal heat exchange tube means, operating temperature and said first fluid.

2. The heat exchange tube assembly of claim 1, with said metal heat exchange tube means having a smooth inner and outer wall surfaces.

3. The heat exchange tube assembly of claim 1, with said metal heat exchange tube means having a smooth inner wall surface and an extended outer wall surface.

4. The heat exchange tube assembly of claim 1, with said metal heat exchange tube means having the inner wall coated with porous sintered metal deposit and having a smooth outer wall surface.

5. The heat exchange tube assembly of claim 1, with said metal heat exchange tube means having the inner wall coated with porous sintered metal deposit and having an extended outer wall surface.

6. A rotating film shell and tube type heat exchanger for indirect transfer of heat between first fluid passing through a plurality of heat exchange tube assemblies and a second fluid passing through the shell comprising:
a shell having first and second ends, shell headers at said first and second ends, an inlet for said second fluid and an outlet for said second fluid,
a plurality of metal heat exchange tube means positioned within said shell and having opened intake ends for receiving said first fluid, flowing said first fluid there through and having opened outlet ends for discharging said first fluid,
a baffle means inserted and centrally disposed within said heat exchange tube means, said baffle means having a diameter substantially equal to the internal diameter of said heat exchange tube means, said baffle means separating the straight circular channel of said heat exchange tube means into two semi-circularly sectioned spiral channels extending along the length of said heat exchange tube means, said spiral channels providing a rotating spiralling flow path for said first fluid passing there through, said rotating spiralling flow of said first fluid generating centrifugal acceleration within said rotating first fluid and with said baffle means being made of a material chemically compatible with said metal heat exchange tube means, operating temperature and said first fluid,
first fluid inlet means for receiving said first fluid, with said first fluid inlet means being in fluid communication with said inlet ends of said plurality of heat exchange tube means, and
first fluid outlet in fluid communication with said outlet ends of said plurality of heat exchange tube means for discharging said first fluid.

7. The rotating film shell and tube type heat exchanger of claim 6, with said heat exchange tube means having smooth inner and outer wall surfaces.

8. The rotating film shell and tube type heat exchanger of claim 7, with said first fluid inlet means being a spray nozzle distributing said first fluid in a ful cone spray into said intake ends of said plurality of heat exchange tube means.

9. The rotating film shell and tube type heat exchanger of claim 6, with said heat exchange tube means having a smooth inner wall surface and an extended outer wall surface.

10. The rotating film shell and tube type heat exchanger of claim 9, with said first fluid inlet means being a spray nozzle distributing said first fluid in a ful cone spray into said opened ends of said plurality of heat exchange tube means.

11. The rotating film shell and tube type heat exchanger of claim 6, with said heat exchange tube means having the inner wall coated with porous sintered metal deposit and having a smooth outer wall surface.

12. The rotating film shell and tube type heat exchanger of claim 11, with said first fluid inlet means being a spray nozzle distributing said first fluid in a ful cone spray into said opened ends of said plurality of straight heat exchange tube means.

13. The rotating film shell and tube type heat exchanger of claim 6, with said heat exchange tube means having the inner wall coated with porous sintered metal deposit and having an extended outer wall surface.

14. The rotating film shell and tube type heat exchanger of claim 13, with said first fluid inlet means being a spray nozzle distributing said first fluid in a ful cone spray into said opened ends of said plurality of straight heat exchange tube means.

15. The rotating film shell and tube type heat exchanger of claim 6, with said first fluid and said second fluid being liquids.

16. The rotating film shell and tube type heat exchanger of claim 6, with said first fluid being a liquid and said second fluid being a condensing vapour.

17. The rotating film shell and tube type heat exchanger of claim 6, with said first fluid being a two-phase fluid of a boiling liquid and vapour and said second fluid being a liquid.

18. The rotating film shell and tube type heat exchanger of claim 6, with said first fluid being a two-phase fluid of a boiling liquid and vapour and said second fluid being a condensing vapour.

19. The rotating film shell and tube type heat exchanger of claim 6, with said first fluid being a two-phase fluid of a boiling liquid and vapour and said second fluid being a gaseous fluid.
